(19) United States
(12) Patent Application Publication
(10) Pub. No.: US 2017/0171652 A1
(43) Pub. Date: Jun. 15, 2017

(54) MEMS MICROPHONE AND MANUFACTURING METHOD THEREOF

(71) Applicant: Hyundai Motor Company, Seoul (KR)

(72) Inventor: Ilseon Yoo, Suwon (KR)

(21) Appl. No.: 15/187,234

(22) Filed: Jun. 20, 2016

(30) Foreign Application Priority Data
Dec. 11, 2015 (KR) 10-2015-0177470

(51) Int. Cl. H04R 1/04; H04R 19/00; H04R 19/04

(52) U.S. Cl. CPC H04R 1/04; H04R 19/04; H04R 19/005; H04R 2201/003

(57) ABSTRACT

A micro-electro-mechanical system (MEMS) microphone and a manufacturing method thereof are provided. The MEMS microphone includes a substrate that is formed from a flexible polymer. A sound sensing component is disposed at a first side of the substrate and includes a fixing membrane and a vibration membrane for sensing a sound. A signal processor is disposed at a second side of the substrate and is electrically connected to the sound sensing component while being spaced apart from each other.

### CROSS-REFERENCE TO RELATED APPLICATION

This application claims priority to and the benefit of Korean Patent Application No. 10-2015-0177470 filed in the Korean Intellectual Property Office on Dec. 11, 2015, the entire contents of which is incorporated herein by reference.

### BACKGROUND

(a) Field of the Invention

The present invention relates to a micro-electro-mechanical system (MEMS) microphone and a manufacturing method thereof and more particularly, to a MEMS microphone and a manufacturing method thereof that measures sound in a high temperature area by disposing a sound sensing component and a signal processor spaced apart from each other by a predetermined distance in a substrate formed from a flexible polymer.

(b) Description of the Related Art

Recently, the size of a microphone that converts a sound into an electrical signal has been minimized The microphone having a reduced size has been developed based on a micro-electro-mechanical system (MEMS) technology. In particular, a MEMS microphone provides improved humidity resistance and heat resistance when compared with a typical electret condenser microphone (ECM), and may be integrated with a signal processing circuit.

Typically, the MEMS microphone is used with a portable communication device including a smartphone, an earphone, a hearing aid, and the like, and is classified into a capacitive type of microphone or a piezoelectric type of microphone. The capacitance type of MEMS microphone includes a fixing membrane and a vibration membrane. For example, when external sound pressure is applied to the vibration membrane, a capacitance value thereof is changed due to a change in an interval between the fixing membrane and the vibration membrane is changed. Sound pressure is measured based on an electrical signal generated at this time. The piezoelectric type of MEMS microphone includes only a vibration membrane. In particular, when the vibration membrane is deformed by an external sound pressure, an electrical signal is generated due to a piezoelectric effect and the sound pressure is measured based on the electrical signal.

Currently, the majority of MEMS microphones are the capacitance type of MEMS microphone. However, the use of MEMS microphone applied to a communication device have recently increased in an industrial mechanical apparatus or a in a vehicle when a substantial amount of noise is generated to measure the noises therein. However, when the typical MEMS microphone is used in a high temperature area of a vehicle such as an engine compartment, a signal processing circuit may operate unstably. Moreover, when the typical MEMS microphone is applied to an industrial mechanical apparatus, it is coupled to a curved portion of the industrial mechanical apparatus, thus increasing the difficulty to perform accurate measurement.

The above information disclosed in this section is merely to enhance the understanding of the background of the invention and therefore it may contain information that does not form the prior art that is already known in this country to a person of ordinary skill in the art.

### SUMMARY

The present invention provides a MEMS microphone and a manufacturing method thereof that may measure sound in a high temperature area by disposing a sound sensing component and a signal processor to be spaced apart from each other by a predetermined distance in a substrate formed from a flexible polymer.

According to an exemplary embodiment a micro-electro-mechanical system (MEMS) microphone may include a substrate formed from a flexible polymer, a sound sensing component disposed at a first side of the substrate and having a fixing membrane and a vibration membrane configured to sense a sound and a signal processor disposed at a second side of the substrate and electrically connected to the sound sensing component while the sound sensing component and the signal processor are spaced apart from each other.

The sound sensing component may include a fixing membrane formed from a rigid material and disposed on a first side surface of the substrate, a vibration membrane having a space with a plurality of sound apertures are disposed and an end portion of a circumferential surface of may be coupled to an edge of an upper surface of the fixing membrane. A first electrode may be disposed on the upper surface of the fixing membrane. A second electrode may be disposed at an interior surface of the vibration membrane. A supporting member may be disposed along an interior circumferential surface of the vibration membrane to maintain a distance between the first electrode and the second electrode in the space between the fixing membrane and the vibration membrane.

The first electrode may penetrate through a first side of the vibration membrane to be connected to the signal processor disposed at the second side of the substrate. The second electrode may penetrate through the second side of the vibration membrane to be connected to the signal processor disposed at the second side of the substrate. The second electrode may be coupled to the vibration membrane and may include a plurality of sound apertures. The sound sensing component and the signal processor may be electrically connected through the first electrode and the second electrode and may be configured to output a sound signal sensed by the sound sensing component to the signal processor.

The supporting member may be formed from at least one selected from the group consisting of aluminum (Al), copper (Cu), and an alloy thereof. The substrate may be formed from of a polyimide. The fixing membrane may be formed from an SU-8 material to maintain a planer geometry. The signal processor may be an application specific integrated circuit (ASIC).

The MEMS microphone may be coupled to a surface having a curved shape. Additionally, the sound sensing component and the signal processor of the MEMS microphone may be positioned to be spaced apart from each other by a predetermined distance and may be configured to measure a sound in a high temperature area.

Further, effects that may be obtained or expected from exemplary embodiments of the present invention are directly or suggestively described in the following detailed description. That is, various effects expected from exemplary embodiments of the present invention will be described in the following detailed description.

### BRIEF DESCRIPTION OF THE DRAWINGS

The above and other objects, features and advantages of the present disclosure will be more apparent from the following detailed description taken in conjunction with the accompanying drawings.

FIG. 1 illustrates an exemplary schematic top plan view of a MEMS microphone according to an exemplary embodiment of the present invention;

FIG. 2 illustrates an exemplary schematic cross-sectional view of a sound sensing component of a MEMS microphone according to an exemplary embodiment of the present invention;

FIG. 3 illustrates an exemplary view in which a sound sensing component of a MEMS microphone according to an exemplary embodiment of the present invention is applied to a curved surface; and

FIG. 4 to FIG. 9 sequentially illustrate exemplary processing diagrams of a method for manufacturing a sound sensing component of a MEMS microphone according to an exemplary embodiment of the present invention.

### DETAILED DESCRIPTION

Hereinafter, exemplary embodiments of the present invention will be described with reference to the accompanying drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed there between.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Although an exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

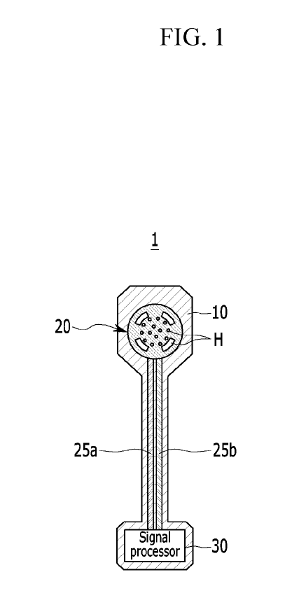

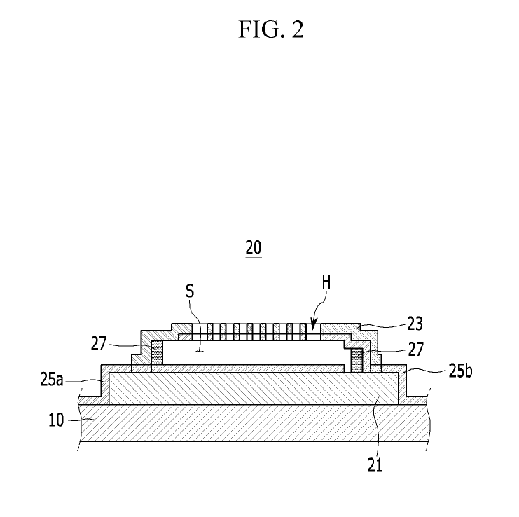

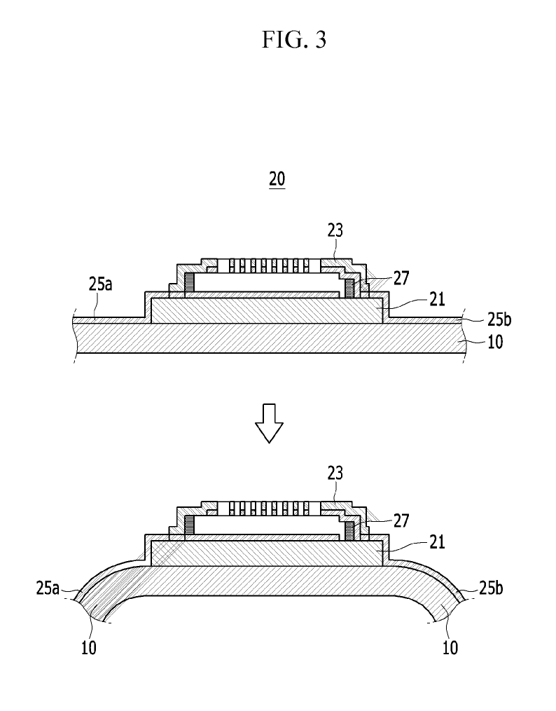

FIG. 1 illustrates an exemplary schematic top plan view of a MEMS microphone according to an exemplary embodiment. FIG. 2 illustrates an exemplary schematic cross-sectional view of a sound sensing component of a MEMS microphone according to an exemplary embodiment. FIG. 3 illustrates an exemplary view in which a sound sensing component of a MEMS microphone according to an exemplary embodiment is applied to a curved surface.

Referring to FIG. 1 and FIG. 2, a MEMS microphone 1 according to an exemplary embodiment of the present invention may include a substrate 10, a sound sensing component 20, and a signal processor 30. The substrate 10 may be formed of a flexible polymer. The flexible polymer may be a polyimide. Physical properties of the polyimide are consistent in a wide temperature range of from about -300 ° C. to +400 ° C., and the polyimide has high heat resistance, electrical insulating properties, flexibility, non-flammable properties, etc.

The substrate 10 may be formed to have a rectangular shape with a constant width from a first end thereof to the second end thereof, and may be cut and used in a desirable shape. The sound sensing component 20 may be formed at a first side of the substrate 10 and may include a fixing membrane 21, a vibration membrane 23, a first electrode 25a, a second electrode 25b and a supporting member 27. The fixing membrane 21 may be formed on a first surface of a first side of the substrate 10. Since the fixing membrane 21 may be formed from a rigid material, as shown in FIG. 3, the fixing member may maintain a planer geometry even when being coupled to a curved surface. The fixing membrane 21 may be formed from an SU-8 material. The SU-8 material is well known in a MEMS manufacturing field, and has a simple manufacturing process, stable and excellent rigidity characteristics, etc.

An end portion of the vibration membrane 23 may be coupled to an edge of an upper surface of the fixing membrane 21. Accordingly, a space (S) may be formed within the vibration membrane 23. A plurality of sound apertures (H) may be formed in an upper portion of the vibration membrane 23. The sound aperture (H) may be formed to have a predetermined micro-size through which an external sound may flow to vibrate the vibration membrane 23. When an external sound flows in through the sound apertures (H), the vibration membrane 23 may be configured to vibrate and a distance between the fixing membrane 21 and the vibration membrane 23 varies. Accordingly, the capacitance between the fixing membrane 21 and the vibration membrane 23 may vary.

The first electrode 25a may be disposed on the upper surface of the fixing membrane 21. The first electrode 25a may penetrate through a first side of the vibration membrane 23 to be connected to the signal processor 30 disposed at the second side of the substrate 10. For example, the first electrode 25a may penetrate through the first side of the vibration membrane 23 on a plane exposed to the exterior. The second electrode 25b may be disposed at an interior surface of the vibration membrane 23. The second electrode 25b may penetrate through the second side of the vibration membrane 23 and may be connected to the signal processor 30 disposed at the second side of the substrate 10. For example, the second electrode 25b may penetrate through the second side of the vibration membrane 23 on a plane exposed to the exterior. The first electrode 25a and the second electrode 25b may be formed to have a predetermined pattern in the sound sensing component 20, while formed to prevent contact with each other.

The supporting member 27 may be disposed along an interior circumference surface of the vibration membrane 23. The supporting member 27 may be disposed to maintain the distance between the first electrode 25a and the second electrode 25b within in the space (S) between the fixing membrane 21 and the vibration membrane 23. The supporting member 27 may be made of at least one of aluminum (Al) and copper (Cu). The signal processor 30 may be disposed at the second side of the substrate 10. The signal processor 30 may be electrically connected to the sound sensing component 20 when the signal processor 30 and the sound sensing component 20 are spaced apart from each other by a predetermined distance. For example, the sound sensing component 20 and the signal processor 30 may be electrically connected to each other by the first electrode 25a and the second electrode 25b. The signal processor 30 may include an application specific integrated circuit (ASIC).

In the MEMS microphone 1 described above, as a sound may be applied to the sound sensing component 20 disposed at a first side of the substrate 10 and may be configured to vibrate the vibration membrane 23. The distance between the fixing membrane 21 and the vibration membrane 23 may vary and the capacitance therebetween may also vary. The varied capacitance may be configured to be output to the signal processor 30 disposed at the second side of the substrate 10 through the first electrode 25a and the second electrode 25b.

Accordingly, in the MEMS microphone 1, the substrate 10 formed from the flexible polymer, the sound sensing component 20 and the signal processor 30 may be disposed to be spaced apart from each other by a predetermined distance. In particular, the sound sensing component 20 of the MEMS microphone 1 may be installed in a harsh environment of a vehicle, for example, in an engine compartment with a high temperature. Further, the signal processor 30 may be installed to be remotely spaced apart from the sound sensing component 20. Accordingly, highly sensitive performance of the MEMS microphone 1 may be achieved even in a high temperature environment.

A manufacturing method of the MEMS microphone according to the exemplary embodiment of the present invention will now be described.

The substrate 10 made of the flexible polymer may be prepared and the sound sensing component 20 and the signal processor 30 may be formed at the first side and the second side of substrate 10, respectively. The sound sensing component 20 and the signal processor 30 may be electrically connected through the first electrode 25a and the second electrode 25b, and their positions may be interchangeable. The signal processor 30 may be manufactured by a typical semiconductor circuit forming method, thus a detailed description thereof will be omitted.

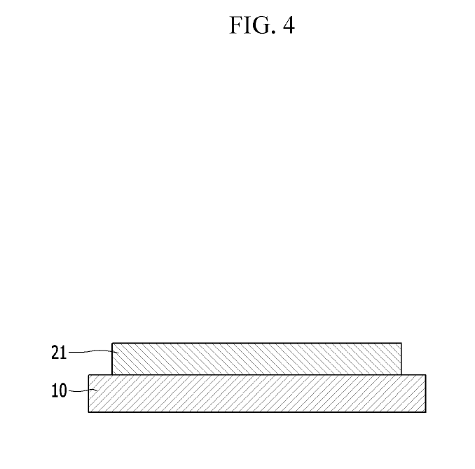

A method of forming the sound sensing component 20 will now described with reference to FIG. 4 to FIG. 9. FIG. 4 to FIG. 9 sequentially illustrate processing diagrams of a method for manufacturing the sound sensing component of the MEMS microphone according to the exemplary embodiment of the present invention.

Referring to FIG. 4, the fixing membrane 21 may be formed on a first side surface of the substrate 10. In particular, the fixing membrane 21 may be formed of an SU-8 material which is a rigid material. The fixing membrane 21 may be formed by spin coating. Spin coating includes a coating method that drips a coating material or a coating liquid material on a substrate and then rotates the substrate at a high speed to spread the coating material or the coating liquid material on a substrate in a film-like fashion. For example, it is exemplarily described that the fixing membrane 21 is formed by spin coating, but the present invention is not limited thereto, and the fixing membrane 21 may be formed by other methods.

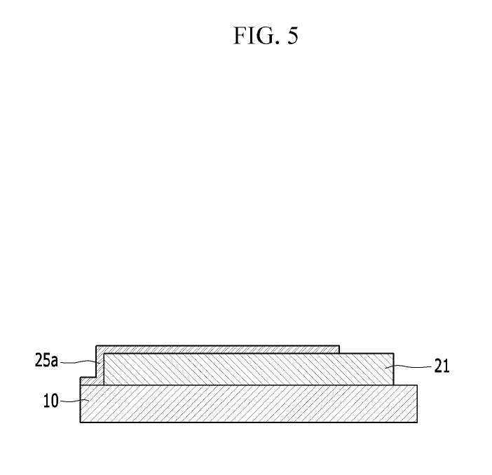

Referring to FIG. 5, the first electrode 25a may be formed on the fixing membrane 21. The first electrode 25a may be formed from a metal material.

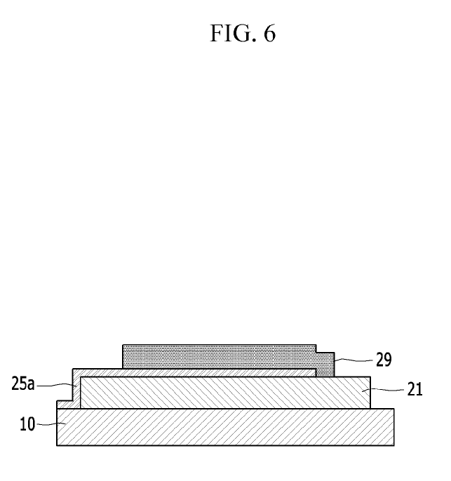

Referring to FIG. 6, a sacrificial layer 29 may be formed on the first electrode 25a and the fixing membrane 21. The sacrificial layer 29 may be formed from at least one of aluminum (Al) and copper (Cu).

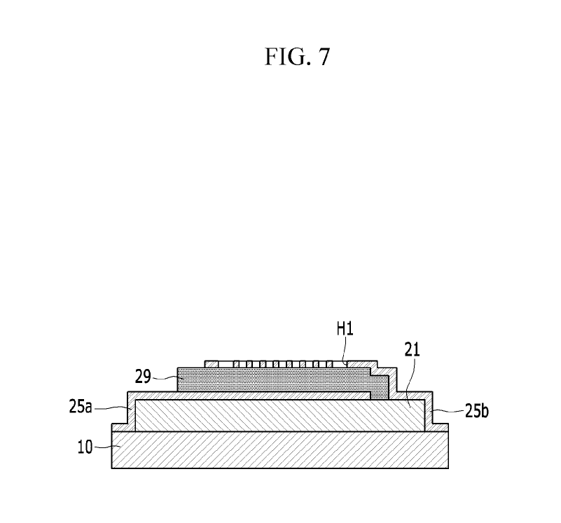

Referring to FIG. 7, the second electrode 25b may be formed on the sacrificial layer 29 and the fixing membrane 21. In particular, a plurality of first sound apertures H1 may be formed in the second electrode 25b disposed on the sacrificial layer 29.

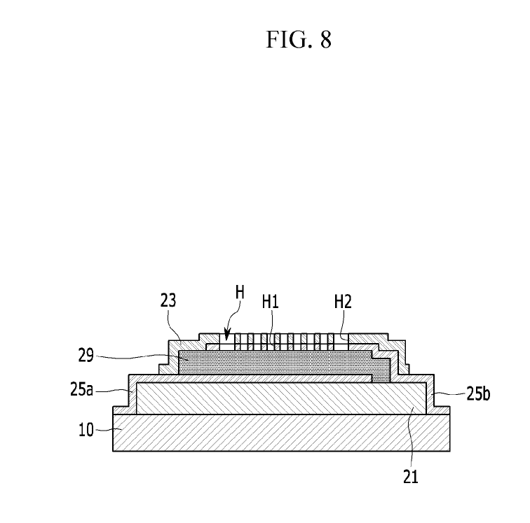

Referring to FIG. 8, the vibration membrane 23 may be formed on the first electrode 25a, the sacrificial layer 29, and the second electrode 25b. Then, a plurality of second sound apertures H2 may be formed in the vibration membrane 23 to correspond to the first sound apertures H1. For example, the first sound apertures H1 and the second sound apertures H2 may be connected to each other to form integrated sound apertures (H).

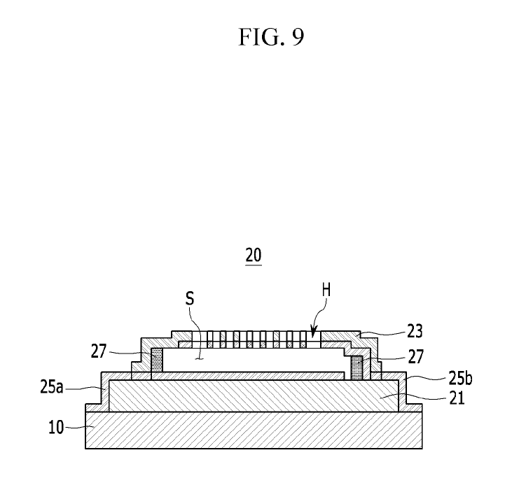

Referring to FIG. 9, the supporting member 27 that support the vibration membrane 23 and the second electrode 25b may be formed by partially removing the sacrificial layer 29. Accordingly, the supporting member 27 may be formed along the interior circumference surface of the vibration membrane 23. For example, the supporting member 27 may be formed to maintain the distance between the first electrode 25a and the second electrode 25b within the space (S) between the fixing membrane 21 and the vibration membrane 23.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

1 . . . MEMS microphone
10 . . . substrate
20 . . . sound sensing component
21 . . . fixing membrane
23 . . . vibration membrane
25a . . . first electrode
25b . . . second electrode
27 . . . supporting member
29 . . . sacrificial layer
30 . . . signal processor
S . . . space
H . . . sound aperture

What is claimed is:

1. A micro-electro-mechanical system (MEMS) microphone, comprising:
a substrate formed from a flexible polymer;
a sound sensing component disposed at a first side of the substrate and includes a fixing membrane and a vibration membrane configured to sense a sound; and
a signal processor disposed at a second side of the substrate and electrically connected to the sound sensing component,
wherein the signal processor is spaced apart from the sound sensing component.

2. The MEMS microphone of claim 1, wherein the sound sensing component includes:
a fixing membrane formed from a rigid material and disposed on the first side surface of the substrate;
a vibration membrane having a space in which a plurality of sound apertures are formed and an end portion of a circumferential surface coupled to an edge of an upper surface of the fixing membrane;
a first electrode disposed on the upper surface of the fixing membrane;
a second electrode disposed at an interior surface of the vibration membrane; and
a supporting member disposed along an interior circumferential surface of the vibration membrane configured to maintain a distance between the first electrode and the second electrode in the space between the fixing membrane and the vibration membrane.

3. The MEMS microphone of claim 2, wherein the first electrode penetrates through a first side of the vibration membrane coupled to the signal processor disposed at the second side of the substrate.

4. The MEMS microphone of claim 2, wherein the second electrode penetrates through the second side of the vibration membrane coupled to the signal processor disposed at the second side of the substrate.

5. The MEMS microphone of claim 2, wherein the second electrode is coupled to the vibration membrane and has a plurality of sound apertures.

6. The MEMS microphone of claim 2, wherein the sound sensing component and the signal processor are electrically connected via the first electrode and the second electrode and configured to output a sound signal sensed by the sound sensing component to the signal processor.

7. The MEMS microphone of claim 2, wherein the supporting member is formed from of at least one selected from the group consisting of: aluminum (Al), copper (Cu), and an alloy thereof.

8. The MEMS microphone of claim 1, wherein the substrate is formed from a polyimide.

9. The MEMS microphone of claim 1, wherein the fixing membrane formed from an SU-8 material to maintain a planer geometry.

10. The MEMS microphone of claim 1, wherein the signal processor is an application specific integrated circuit (ASIC).

11. A manufacturing method of a MEMS microphone, comprising:
preparing a substrate formed from a flexible polymer;
forming a sound sensing component at the first side of the substrate; and
forming a signal processor at a second side of the substrate,
wherein the sound sensing component and the signal processor are electrically connected to each other via an electrode.

12. The manufacturing method of the MEMS microphone of claim 11, wherein the forming of the sound sensing component includes:
forming a fixing membrane on a first side surface of the substrate;
forming a first electrode on the fixing membrane;
forming a sacrificial layer on the first electrode and the fixing membrane;
forming a second electrode on the sacrificial layer;
forming a plurality of first sound apertures in the second electrode;
forming a vibration membrane on the first electrode, the sacrificial layer, and the second electrode;
forming a plurality of second sound apertures in the vibration membrane to correspond to the plurality of first sound apertures; and
forming a supporting member that supports the second electrode and the vibration membrane by partially removing the sacrificial layer.

13. The manufacturing method of the MEMS microphone of claim 12, wherein the forming of the fixing membrane is performed by spin coating.

14. The manufacturing method of the MEMS microphone of claim 11, wherein the substrate is formed from a polyimide.
